(19) United States
(12) Patent Application Publication
(10) Pub. No.: US 2012/0248082 A1
(43) Pub. Date: Oct. 4, 2012

(54) LARGE PANEL ASSEMBLY WELDING SYSTEM AND METHOD

(75) Inventor: Terrence Dillon O'Connell, Davenport, IA (US)

(73) Assignee: Illinois Tool Works Inc., Glenview, IL (US)

(21) Appl. No.: 13/435,299

(22) Filed: Mar. 30, 2012

Related U.S. Application Data
(60) Provisional application No. 61/469,165, filed on Mar. 30, 2011.

(51) Int. Cl. B23K 9/00

(52) U.S. Cl. 219/137 R; 219/136

(57) ABSTRACT

A system for welding large panel assemblies is provided. The system includes at least one transport track extending along an area in which a panel to be welded will be placed. A movable support structure is mounted to move along the transport track. A welding robot is supported by the support structure and configured to move to welding locations where welds are to be completed between a part and the panel. A pressing component is supported by the support structure and configured to press the part toward the panel. A welder is coupled to the welding robot for executing welds at the welding locations, and a control system is configured to command operation of the support structure, the pressing component, the robot, and the welder to execute the welds.

### CROSS-REFERENCE TO RELATED APPLICATIONS

This application is a non-provisional application of U.S. Patent Application No. 61/469,165, entitled “Ship Panel Welding”, filed Mar. 30, 2011, which is herein incorporated by reference in its entirety.

### BACKGROUND

The invention relates generally to welding systems, and, more particularly, to systems and methods for welding large panel assemblies.

A number of construction applications exist in which large plates or panels are fabricated and, in many cases these may be joined in a final structure. For example, panels used in ship construction may consist of many large steel or aluminum plates, typically many feed wide and long. On one side, the panels may be reinforced with cross parts, struts, braces and so forth. In some cases, there may be a number of such parts spaced to provide structural and stiffening support to the panels. Current manual processes are used to layout, assemble, and weld such panels, and these make require to 3 man shifts over the course of 3 days. The manual process may include: 1) making a cut to size sheet of a plate placed on the floor, 2) referencing a design drawing using a tape measure, carpenter tools, and markers to scribe the locations for the various cross parts and weld locations, 3) tack welding the cross parts into the correct position using the marked lines as a guide, 4) using hammers, clamps, or other tools to force closure of gaps created between the cross parts and the panel, and 5) executing cumbersome manual welding of all of the cross parts for each of the many ship panels. Accordingly, it may be useful to automate such construction and welding processes.

Automating the welding process for large panel construction, such as in shipbuilding may be an exigent endeavor, but a significant one, as the construction of ship panels depends greatly on high quality and efficient welding. Conventional robotic welding systems hardly ever suffice, as the welding tasks in shipyards are typically characterized by large and cumbersome panels, cross parts, careful part placement, and assembly of parts atypical both in dimension and geometry. Furthermore, ship panel builders often encounter the problems of poor part fit-up, mismarking of welding locations, and the overall distortion indigenous to the welding process. For example, significant weld joint gaps are often present when attempting to weld the cross parts to the ship panels, further inducing welding distortion and other inaccuracies and inefficiencies.

### BRIEF DESCRIPTION

In one embodiment, a system for welding large panel assemblies is provided. The system includes at least one transport track extending along an area in which a panel to be welded will be placed. A movable support structure is mounted to move along the transport track. A welding robot is supported by the support structure and configured to move to welding locations where welds are to be completed between a part and the panel. A pressing component is supported by the support structure and configured to press the part toward the panel. A welder is coupled to the welding robot for executing welds at the welding locations, and a control system is configured to command operation of the support structure, the pressing component, the robot, and the welder to execute the welds.

In another embodiment, a method for welding large panel assemblies is provided. Based upon assembly weld parameters, a support structure is commanded to move to a location where a part is to be welded to a panel, a pressure is commanded to be exerted near the location to press the part into contact with the panel, and a welding robot and a welder are commanded to execute a weld to join the part to the panel.

In another embodiment, a method for welding large panel assemblies is provided. Based upon assembly weld parameters, a support structure and a marking robot is commanded to move to locations of welds to join a part to the panel and to mark the locations, a support structure is commanded to a location where the part is to be welded to the panel, a pressure is commanded to be exerted near the location to press the part into contact with the panel, and a welding robot and a welder are commanded to execute a weld to join the part to the panel.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exemplary embodiment of a robotic marking and welding system for assembly and welding of large panel assemblies;

FIG. 2 is a perspective view of an exemplary embodiment of the robotic marking and welding system and large panel assembly of FIG. 1;

FIG. 3 is a perspective view of an exemplary embodiment of a welder, a pressing component, and a large panel assembly; and

FIG. 4 is a flow chart of an embodiment of a process suitable for executing marking and welding of large panel assemblies.

### DETAILED DESCRIPTION

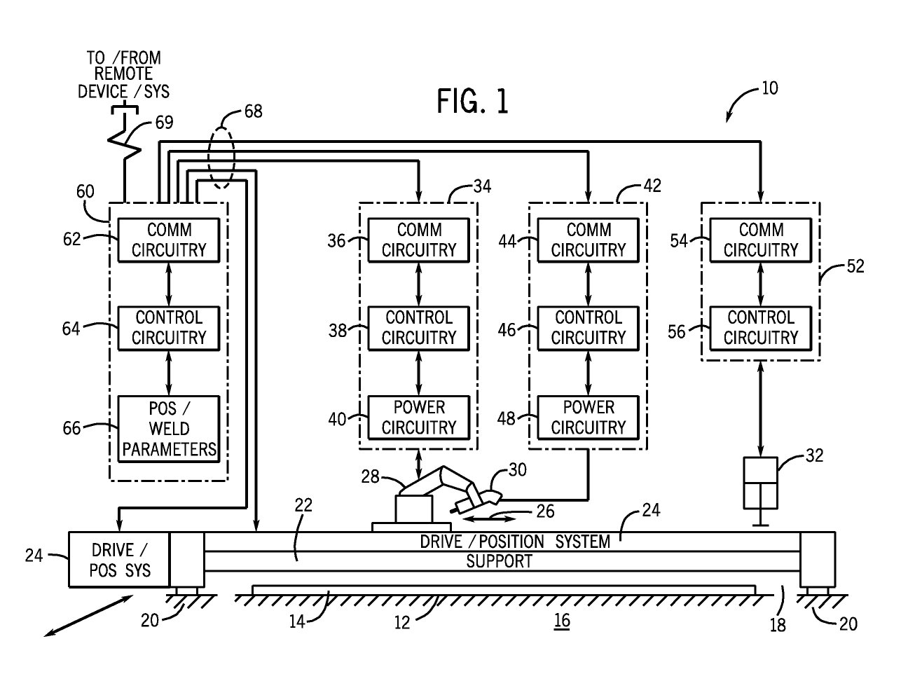

Referring now to the drawings, FIG. 1 illustrates a marking and welding robotic system 10 configured to facilitate handling of large panels 12, and to allow for placement and welding a part 14 to a large panel 12 within an area 16. The panel 12 may be a large plate used as the main structural component in the construction of various structures, such as the body or hull of a ship or other large marine vessel. For example, the panel 12 may be a large (e.g., 3/16′×9′×15′) unstiffened steel or aluminum plate configured and welded together with many other similar panels to form the hull, bulkheads, internal partitions, and other sections of a ship. Additional rigidity and stiffness of the panel 12 may be desired beyond those obtainable by the panel alone. As will be discussed in greater detail, the panel 12 may be effectively assembled with other parts and stiffened by welding one or more such parts 14 at specific welding locations 18. Within the system 10, the panel 12 may be placed in the area 16, which may be, for example, the floor of a fabrication facility or other industrial construction and design facility, or a horizontal or angled table raised from the floor.

As noted above, in certain embodiments, one or more parts 14 may be coupled to the panel 12 at a multitude of locations 18 to support and reinforce the panel 12. The one or more parts 14 may be long and straight stiffeners, for example, oriented horizontally and/or vertically across the panel 12. The one or more parts 14 may be composed of a metal material (e.g., aluminum, steel, etc.), and may be welded at spaced locations 18, such that the parts 14 provide desired rigidification, attachment points, and so forth in accordance with the panel specifications. As will be discussed in greater detail, when placed at specified welding locations 18, weld joint gaps may be present the one or more parts 14 and the panel 12, and these may be closed during the welding process to enhance fitup of the joints and provide the desired weld quality.

In certain embodiments, the robotic marking and welding system 10 may further include a transport track 20. The transport track 20 may be a main component of an infrastructure used to facilitate the mobility of a support structure 22. A drive positioning system 24 allows for moving the support structure over a predetermined distance of travel 26. The support structure will typically support a welding robot 28 that includes a welding torch or assembly 30, as well as a pressing component 32 that allows for pressing on parts to close gaps and improve fitup. The transport track 20 may include parallel rails extending to, or beyond the length of the panel 12 to execute marking and welding. For example, for a 15′×10′×2′ panel 12, the transport track 20 may be designed to extend, for example, over 20′ or more, such that the support structure 22 and welding robot 28 may be enabled to service the complete length of the panel 12. In addition, the transport track 20 may also include an array of roller wheels or other mechanical systems to further facilitate the mobility of the support structure 22. For example, the transport track 20 may be similar to industrial railroad tracks. In other embodiments, the transport track 20 may comprise one or a series of linear floor tracks, wall-mounted tracks, or linear and radial gantries, and so forth.

As previously discussed, linear floor tracks may allow the support structure 22 and welding robot 28 to reach individual welding locations 18 on very long panels 12. In some cases, it may be necessary to mount a transport track 20 in an elevated vertical position, thus allowing the support structure 22 and welding robot 28 to perform markings and welds from an overhead position. The support structure 22 and welding robot 28 may then be enabled to reach not only more widely spaced locations 18 of the panel 12, but also down into crevices that may be present within or about the panel 12. As will be discussed in greater detail, the drive positioning system 24 may be a servo-controlled to allow for programmability and automated or semi-automated positioning of the support structure 22 and welding robot 28 anywhere along a distance of travel 26 of the transport track 20.

In certain embodiments, the support structure 22 may be a spanning support framework coupled to travel a distance 26 along the transport track 20. The support structure 22 may also provide a base and support for one or more welding robots 28 and welding torches 30. For example, the support structure 22 may be a large linear or radial gantry configured to support and allow movement of the welding robot 28 in either a floor-up or overhead orientation to reach a multitude of welding locations 18. A linear gantry embodiment of support structure 22 may extend the work envelop of the welding robot 28 beyond the reach afforded by the transport track 20 alone. This may be accomplished by the linear gantry embodiment of the support structure 22 further providing for two- or three-dimensional movement. For example, while the x-axis may be the distance of travel 26 of the support structure 22, the y-axis of travel may allow the welding robot 28 to move perpendicular to the x-axis (i.e., distance of travel 26). In addition, a vertical z-axis may allow the welding robot 28 to reach into crevices to perform welds. In a presently contemplated embodiment, the robot may carry out welds at any location along the length and width of the panel. Moreover, a radial gantry embodiment of support structure 22 may include a rotary based boom to support the welding robot 30. In such an embodiment, the support structure 22 may increase the degrees of freedom of the welding robot 28 by supporting it as a cantilevered load. Such cantilevered arrangements may also be envisioned for linear motion of the support structure and robot.

As noted above, coupled to the transport track 20 and support structure 22 may be a drive positioning system 24. The drive positioning system 24 may consist of a system of track wheels, servo motors (e.g., DC/AC electric motors), actuators, and similar devices programmed and powered to convert electrical command signals into a mechanical force and motion to drive, rotate, and position the mechanically and electrically coupled support structure 22. For example, the drive positioning system 24 may include a system of programmable logic controllers to drive and steer the support structure 22 to predetermined welding locations 18 of the panel 12. The drive positioning system 24 may also include other electrical and mechanical instrumentation (e.g., position sensors, speed sensors, global positioning systems, motion detectors, etc.) to detect and record support structure drive position coordinates, steering and braking accuracy, dispatch response time, and so forth. For example, the drive positioning system 24 may continuously detect and record the drive position of support structure 22 as compared to the predetermined route position of the support structure 22, and report such data to a communicatively coupled central control system for closed loop control of the support system positioning.

As previously discussed, in certain embodiments, a welding robot 28 and welding torch 30 may be electrically and mechanically coupled to the support structure 22. The welding robot 28 may be a multipurpose robotic arm or manipulator capable of extending along one or more axes. For example, the welding robot 28 may include DC motors or hydraulic actuators at each of the joints of the arm and wrist of the welding robot 28, such that the degrees of freedom of the welding robot 28 may be increased to perform welds and/or weld markings. In certain embodiments, the welding robot 28 may be pre-programmed via a desktop computer, laptop computer, automation controller, industrial network control system, and so forth. For example, the welding robot 28 may be a programmable industrial robot capable of learning (e.g., via programming and iterative instruction) positional data and iterative procedures (e.g., marking and welding). For example, in performing a task to move to a weld location 18 of panel 12, the welding robot 28 may be programmed to recognize the position of the welding location 18 of the panel 12, and to extend the welder 32 to that specified position. In a presently contemplated embodiment, however, operation of the robot and welding system is coordinated by a central or common control system that allows for appropriate positioning and execution of marking and welding.

As further depicted in FIG. 1, the programming and control of the welding robot 28 may be executed via a robot controller 34. The robot controller 34 may provide the primary control of the welding robot 28, controlling parameters such as movement, positioning, orientation, and so forth. The robot controller 34 may include communications circuitry 36, as well as control circuitry 38, that will typically comprise a processor and memory to execute and store, for example, computer-readable instructions containing software control algorithms for moving the robot along the support structure and positioning of the welding torch. Power circuitry 40 may thus receive instructions for motion of the robot as desired for the marking and welding operations. The communications circuitry 36 of the robot controller 34 may enable communication via direct connection to external control and/or monitoring equipment or via any suitable network, such as a local area network, wide area network, wireless network, and so forth, and in accordance with any desired protocol, such as Internet protocols, industrial data exchange protocols, and so forth. The control circuitry 38 may store and execute instructions relating to positions and movements toward those positions, for example, of parts 14 and/or welding locations 18 of panel 12. In a similar example, the control circuitry 38 may be configured to interpret instructions from a central control system to execute movement to desired locations for marking and welding. Such commands may include a sequence to, for example, move to a specified part 14 at a welding location 18 of panel 12, position the welding torch 30 at a desired distance from the part 14, and lastly, execute a weld of the part 14 to the panel 12. Based upon such commands, the power circuitry 40 may control motors and actuators of the robot.

As also noted above and further depicted in FIG. 1, a welder may be electrically and mechanically coupled to the welding robot 28. The welding robot 28 may be programmed and/or controllable to position the welding torch 30 at desired locations with respect to a panel 12. The welding torch 30 may then act to initiate arcs between an electrode and one or more parts 14 and panel 12, while the welding robot 28 may be controlled to advance the welding torch 30 along a predefined path where a weld bead is to be established to join the one or more parts 14 and panel 12.

A welding system comprising the welding torch 30 will typically include a welding power supply 42 designed to provide power and control signals to perform a number of welding applications, such as a metal inert gas (MIG) welding process, although other processes such as tungsten inert gas (TIG) welding, air plasma cutting, stick welding, a flux cored welding, and so forth may also be performed. Accordingly, the welding system may also include various components, connections, and tools, such as a wire feeder, a shielding gas source, and so forth. Similar to the robot controller 34, the welder controller 42 may include communications circuitry 44, a control circuitry 46, and power circuitry 48. The communications circuitry 44 of the welder may enable welder to communicate via any suitable wired or wireless network, and in accordance with any desired protocol. The control circuitry 46 operates to control generation of welding power output that is applied to the welder 30 for carrying out desired welding operations (e.g., ship panel welding). As will be appreciated by those skilled in the art, such power is typically converted from single or three-phase power input to the power circuitry, although other sources of power might include batteries, engine-generators, ultracapacitors, and so forth. The power circuitry 48 may be adapted to create the output power in accordance with particular welding regimes, such as pulsed waveforms that will ultimately be applied to the welding torch 30. The power circuitry 48 may also include various power conversion circuits such as, for example, choppers, boost circuitry, buck circuitry, inverters, converters, and so forth.

It should be noted that the robotic system and welding system described above may be adapted for making of desired part placement and weld locations as well. That is, the robot may be adapted to hold marking devices, such a spray head to spray paint, ink or any other marking medium to mark locations where the parts should be placed and/or where welds should be made. Mechanical means, such as scribes and contact markers may also be used. Where the robot is not equipped for such marking, and where automated marking is desired, an additional or supplemental robot may be provided for this purpose. When provided, such a robot will typically include processing and memory circuitry, as well as communications and power circuitry similar to that of the welding robot described above, allowing movement of the marking medium to desired locations in a manner similar to the movement of the welding torch.

In certain embodiments, the robotic marking and welding system 10 may also include pressing component 32, or two or more such components. The pressing component 32 may be mechanically coupled to the support structure 22. The pressing component 32 may comprise, for example, a pneumatic, hydraulic, or electrically powered cylinder or actuator used to exert a mechanical force to press a part 14 to the panel 12 to be welded. For example, in certain embodiments, a part 14 may be placed at a predetermined welding location 18 of panel 12, and a weld joint gap may be created between the part 14 and panel 12, such that if a weld is attempted, it could result in significant welding distortion or an inferior joint. The force of the pressing component, in conjunction with the weight of the support structure allows such gaps to be closed, at least during the time when desired welds are performed.

The pressing component 32 may be further controlled by a press controller 52, which may include a communications circuitry 54 and a control circuitry 56. Similar to the robot controller 34 and welder controller 42, the communications circuitry 54 of the pressing component 32 may enable the pressing component controller to communicate via a wired or wireless connection with external control and/or monitoring equipment, and in accordance with any desired protocol. The control circuitry 56 may transmit control commands to actuate the pressing component 32 to exert a specified force when desired. For example, the pressing component 32 may receive electrical command signals to press a part 14 to the panel 12. The control circuitry itself may include electrical components, control valving, and so forth, the latter being particularly used in connection with pneumatic and/or hydraulic actuators for their extension and retraction.

In certain embodiments, the drive positioning system 24, the robot controller 34, the weld controller 42, and the press controller 52 may each be controlled and commanded by a central control system 60. The central control system 60 may include communication circuitry 62 and devices (e.g., host servers, gateways, routers, etc.), control circuitry 64 (e.g., one or more automation controllers, industrial computers, I/O modules, alarms, etc.), and may store position and weld parameters and instructions 66. The central control system 60 may schedule system tasks (e.g., markings and welding), manage the system storage and/or database, control input/output operations, handle communication with the downstream controllers (e.g., the robot controller 34, the welder controller 42, and the press controller 52) via a network 68 or wirelessly, and execute various welding applications. The control system 60 may allow an operator, for example, to program weld parameters (e.g., dimensions, geometries, 2-D/3-D models, etc.) offline at a desktop computer, or online via the network 68.

In a presently contemplated embodiment, for example, specifications for placement of parts at desired locations on the panel, and for the locations and types of welds may be stored in the control system 60, or transmitted to the system from external or even remote systems or devices, as indicated by reference numeral 69. The specifications may include the position and weld parameters in accordance with higher-level construction designs for the panel and the structure in which the panel will be used. The position and weld parameter instructions 66 may include the dimensions of, for example, the one or more parts 14 and panel 12. For example, as previously discussed, the panel 12 may be a large (e.g., 3/16′×9′×15′) unstiffened aluminum plate, while the one or more parts 14 may likewise be long (e.g., 5′-10′) metal stiffeners to be welded at predetermined locations 18 of the panel 12. In certain embodiments, the operator, for example, may program such parameters as metal type, the size and dimensions, and the geometries of the panel 12 and the part 14. The operator may then program the position (e.g., physical coordinates) of the weld location 18 of the panel 12. The control system 60 may then perform the necessary calculations and scheduling, and that data may be relayed via network 68 to the robot controller 34, the welder controller 42, and the press controller 52. The support structure 22 may then position the welding robot 28, welder 30, and pressing component 32 to press, mark, and weld the part 14 to the panel 12 at the welding location 18 of the panel 12 based on the programmed weld parameters.

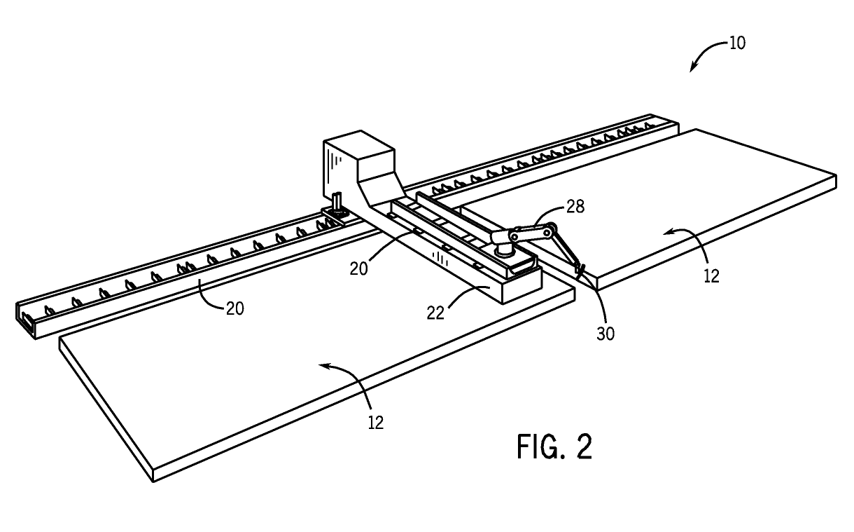

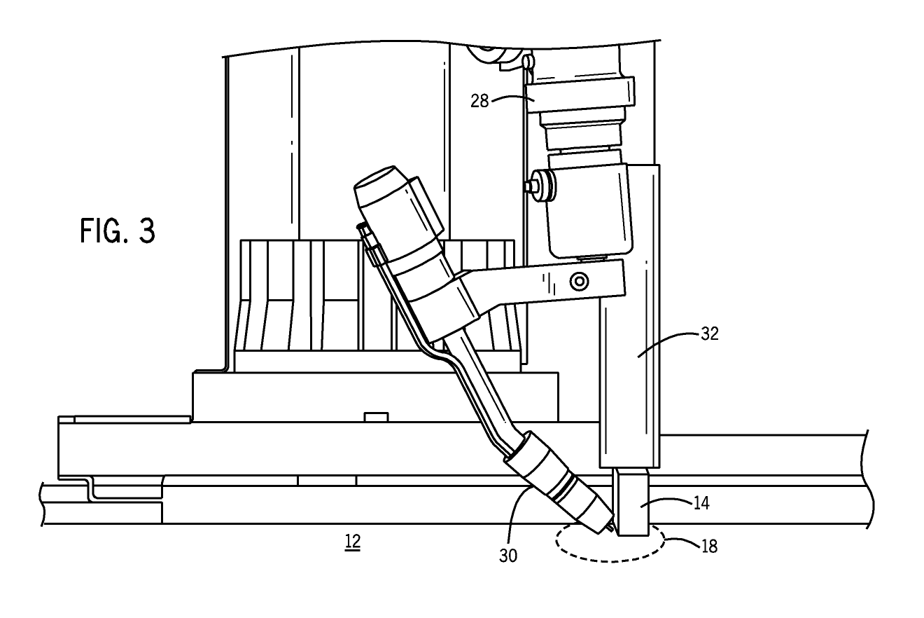

In another embodiment, FIG. 2 displays the robotic system 10 including a panel 12, linear transport track 20, a cantilevered support structure 22 (e.g., boom or gantry) traveling along the transport track 20, and a welding robot 28 mounted to the top surface of the support structure 22. As depicted in FIG. 2, for example, the robotic marking and welding system 10 may further include a mechanism to serially perform welds on a number of panels 12. For example, the robotic marking and welding system 10 may perform a welding of one or more parts 14 on the first panel 12, then may move along the transport track 20 to a second panel 12 to continue welding. Such an embodiment may further increase system 10 reliability and efficiency. It should also be appreciated that additional support structures and robots may also be included to work in parallel along the transport track 20. Similarly, FIG. 3 illustrates an embodiment of a welder (e.g., including weld torch, marking scribe, plasma cutter, etc.) and welding robot 28 configured to perform a weld of a part 14 (e.g., metal stiffener) at a welding location 18 of a panel 12 (e.g., aluminum ship panel). Also shown is a pressing component 32 (e.g., pressure-applying actuated cylinder) coordinated (e.g., with respect to response time and positioning) with the welding torch 30 to first press the part 14 to the panel 12 at the welding location 18 of the panel 12. The part 14 is then welded to the panel 12 by the welder.

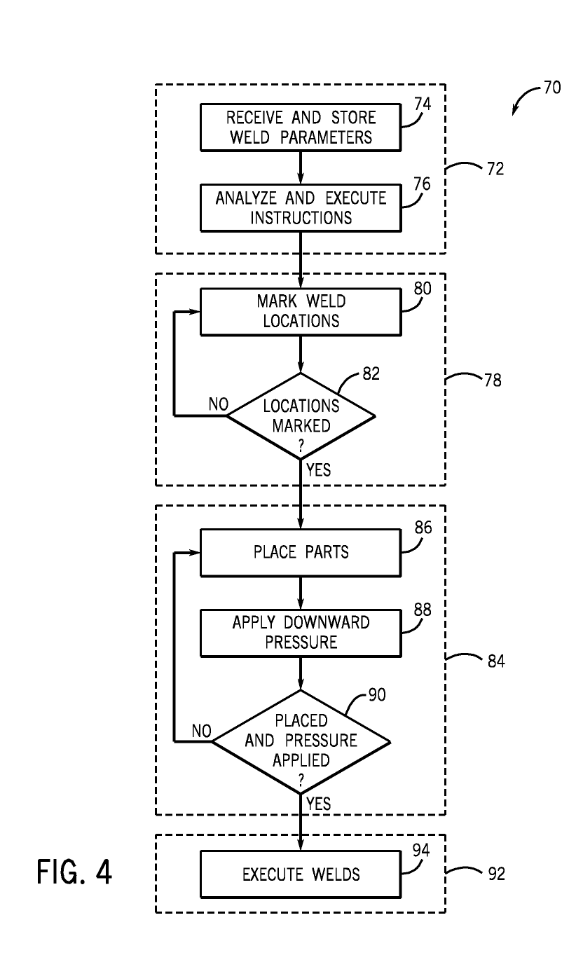

FIG. 4 is a flow chart of an embodiment of a process 70 suitable for implementing a large panel welding process (e.g., as discussed above with respect to FIGS. 1-3). The process 80 may begin with the set-up stage, as indicated generally by reference numeral step 72, by receiving and storing the weld parameters, as indicated at step 74. The weld parameters may then be analyzed, and instructions for performing a marking and welding may be executed, as shown at step 76. Here, it may be worth noting that the set-up stage may be performed offline by an operator at, for example, a desktop computer or laptop, or online over a communications network. The marking stage, indicated generally by reference numeral 78, where implemented, may continue with the marking of the predetermined welding locations at step 80. The process may be performed with welding only, but when marking is performed, the system may verify that all desired locations of parts and/or welds have been marked, as indicated by decision step 82.

Once all marking is determined to be complete, the system may enter a positioning and pressing stage, as indicated by reference numeral 84. While the marking and welding are advantageously done automatically with little manual intervention, the part placement may be done manually where desired. This may be done singly or all parts may be placed in a single phase of the operation, both indicated generally by reference numeral 86. With the parts placed, a downward pressure is then applied to the parts, and tack welds may be executed, as indicated at step 88. Once the parts are placed and tacked, the system may determine whether all parts are placed and tacked, as indicated at step 90.

Finally, a welding stage 92 may be entered to complete the desired welds. This stage involves returning to the locations of the welds and executing them as called for in the assembly specifications. It should be noted that this stage may also involve application of force to close gaps between the parts and the panels to improve fitup and weld quality.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for welding large panel assemblies, comprising:
at least one transport track extending along an area in which a panel to be welded will be placed;
a movable support structure mounted to move along the transport track;
a welding robot supported by the support structure and configured to move to welding locations where welds are to be completed between a part and the panel;
a pressing component supported by the support structure and configured to press the part towards the panel;
a welder coupled to the welding robot for executing welds at the welding locations; and
a control system configured to command operation of the support structure, the pressing component, the robot and the welder to execute the welds.

2. The system of claim 1, comprising first and second transport tracks, one transport track being disposed on each side of the area in which the panel to be welded will be placed.

3. The system of claim 1, comprising a marking robot supported by the support structure and coupled to the control system and configured to mark locations for the welds under the control of the control system.

4. The system of claim 3, wherein the marking robot and the welding robot are the same.

5. The system of claim 1, wherein the welder comprises a metal inert gas welder.

6. The system of claim 1, wherein the pressing component comprises the support structure.

7. The system of claim 1, wherein the pressing component comprises an actuator movable between a non-pressing position and a pressing position in which pressure is placed on the part to be welded to the panel.

8. The system of claim 7, wherein the actuator comprises a fluid cylinder.

9. The system of claim 1, wherein the control system comprises a plurality of controllers associated with the support structure, the robot and the welder.

10. The system of claim 1, wherein the control system is configured to receive assembly weld parameters relating to the welds and to implement the parameters by commanding operation of the support structure, the pressing component, the robot and the welder to execute the welds.

11. The system of claim 10, wherein the control system comprises a plurality of controllers associated with the support structure, the robot and the welder.

12. A method for welding large panel assemblies, comprising:
based upon assembly weld parameters, commanding movement of a support structure to a location where a part is to be welded to a panel;
based upon the assembly weld parameters, commanding a pressure to be exerted near the location to press the part into contact with the panel; and
based upon the assembly weld parameters, commanding a welding robot and a welder to execute a weld to join the part to the panel.

13. The method of claim 12, comprising repeating the steps to execute multiple welds to join the part to the panel at a plurality of locations.

14. The method of claim 12, comprising repeating the steps to execute multiple welds to join multiple parts to the panel.

15. The method of claim 12, comprising, prior to placement of the parts on the panel, commanding operation of the support structure and the same or another robot to mark locations either for placement of the part or execution of the weld, or both.

16. The method of claim 12, wherein operation of the support structure, the robot and the welder is commanded by a plurality of controllers associated with the support structure, the robot and the welder.

17. A method for welding large panel assemblies, comprising:
based upon assembly weld parameter, commanding movement of a support structure and a marking robot to move to locations of welds to join a part to the panel and to mark the locations;
based upon the assembly weld parameters, commanding movement of a support structure to a location where the part is to be welded to the panel;
based upon the assembly weld parameters, commanding a pressure to be exerted near the location to press the part into contact with the panel; and
based upon the assembly weld parameters, commanding a welding robot and a welder to execute a weld to join the part to the panel.

18. The method of claim 17, comprising repeating the steps to mark and execute multiple welds to join the part to the panel at a plurality of locations.

19. The method of claim 17, wherein the marking robot and the welding robot are the same.

20. The method of claim 17, comprising, based upon the assembly weld parameters, commanding movement of the support structure and the marking robot to move to positions where the part is to be placed on the panel and to mark the positions.
